(19) United States
(12) Patent Application Publication
(10) Pub. No.: US 2016/0371240 A1
(43) Pub. Date: Dec. 22, 2016

(54) SERIAL TEXT PRESENTATION

(71) Applicant: Microsoft Technology Licensing, LLC, Redmond, WA (US)

(72) Inventors: Robert Matthew McKaughan, Seattle, WA (US); Jason Anthony Grieves, Bellevue, WA (US); Kevin Larson, Seattle, WA (US); Gregory Hitchcock, Woodinville, WA (US); Michael Martin Bennett, Woodinville, WA (US)

(21) Appl. No.: 14/742,484

(22) Filed: Jun. 17, 2015

(51) Int. Cl. G06F 17/24; G06F 3/01; G06K 9/34; G06F 17/27

(52) U.S. Cl. CPC G06F 17/24; G06F 17/2705; G06F 3/013; G06F 3/017; G06K 9/344

(57) ABSTRACT

A display system comprises a display and a controller operatively coupled to the display. The controller is configured to receive text, parse the text to isolate a segment of the text, compute a time interval for display of the segment, present the segment on the display during the computed time interval, remove the segment from the display following the computed time interval, and repeat the parsing computing, presenting, and removing, for subsequent segments of the text.

### BACKGROUND

A technology consumer may want to keep up to date with important information, even while engaged in another activity. To that end, the consumer may avail herself of portable or wearable display technology, or perform activities in sight of a conventional display screen. In this manner, the consumer may stay connected by way of email, social networking, and short-message-service (SMS) texting, for example.

Unfortunately, reading text may be difficult when other activities are on-going. On compact portable or wearable devices, for example, text is typically displayed in a miniature font, which requires dedicated focus by the user, and even then may be difficult to read. Manipulating the text into view may also be difficult, for example, if scrolling is required. Similar difficulty may be experienced by a consumer engaged in an activity, but trying to read or manipulate text on a conventional display screen located some distance away.

### SUMMARY

An embodiment is directed to a display system configured for ‘smart’ serial text presentation. The display system comprises a display, a sensor, and a controller operatively coupled to the display and to the sensor. The controller is configured to parse the text to isolate a segment of the text, compute a time interval for display of the segment, present the segment on the display during the computed time interval, and remove the segment from the display following the computed time interval. Each segment of the text is presented serially and consecutively, according to this approach.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in this disclosure.

### BRIEF DESCRIPTION OF THE DRAWINGS

FIGS. 1A and 1B show aspects of an example wrist-wearable display system.

FIGS. 2A and 2B show aspects of an example head-wearable display system.

FIG. 3 shows aspects of an example stationary display system with peripheral display and sensory components.

FIG. 4 schematically shows features of an example display system.

FIG. 5 illustrates an example method for providing serial text presentation.

FIG. 6 illustrates serial presentation of a new text message.

FIG. 7 illustrates serial presentation of an already received text message.

FIG. 8 illustrates the process of navigating within a serially presented text message.

FIG. 9 illustrates a scenario in which a long word is presented in the form of a rolling marquee.

FIG. 10 illustrates the act of navigating within a serially presented text message.

### DETAILED DESCRIPTION

One way for a technology consumer to digest textual information without interrupting an on-going activity is through rapid serial visual presentation (RSVP). In this approach, text is presented one word at a time, at a rapid pace, but using a relatively large font size.

RSVP may provide improved text readability for users of wearable and non-wearable display systems under some conditions. This disclosure presents various RSVP improvements, which are believed to extend the usability and efficacy of the technique, and improve the overall user experience. The improvements optimize the speed of delivery of the RSVP presentation according to various conditions and parameters. The resulting display systems and associated methods span numerous embodiments. Accordingly, the drawings listed above illustrate, by way of example, three different display systems each configured for serial text presentation. Each display system includes a controller 10 operatively coupled to at least one sensor 12 and to a display 14. The display, at least, may be wearable, portable, or otherwise movable to within sight of the user. These example display-system configurations are further described below.

Components, and other elements that may be substantially the same in one or more configurations are identified coordinately and described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

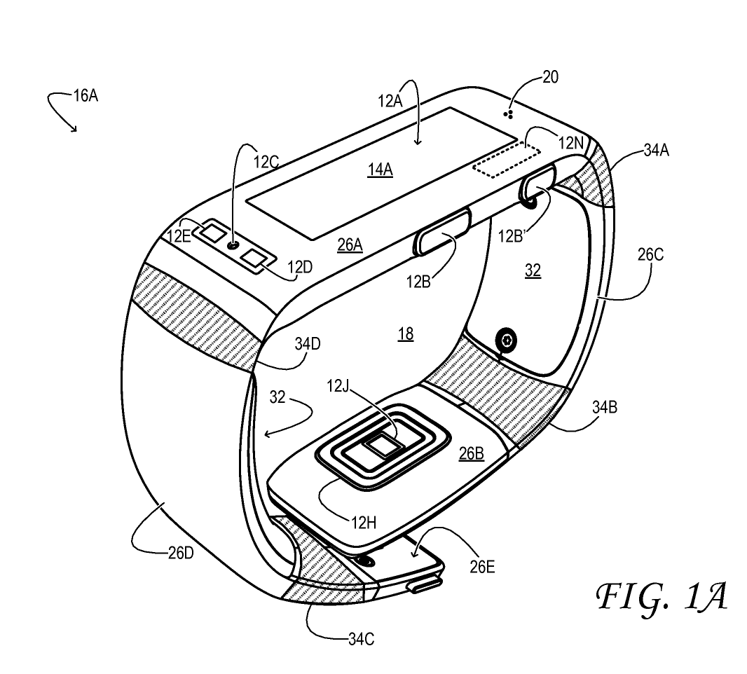

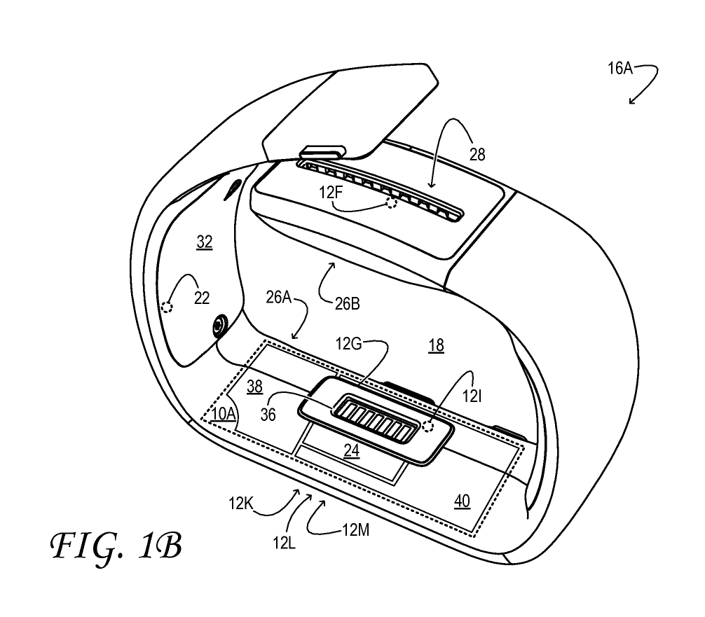

FIGS. 1A and 1B show aspects of an example display system 16A in the form of a wearable electronic device. The illustrated device takes the form of a composite band 18. In one implementation, a closure mechanism enables facile attachment and separation of the ends of the composite band, so that the band can be closed into a loop and worn on the wrist. In other implementations, the device may be fabricated as a continuous loop resilient enough to be pulled over the hand and still conform to the wrist. Alternatively, the device may have an open-bracelet form factor in which ends of the band are not fastened to one another. In other implementations, wearable electronic devices configured to display virtual reality and/or augmented reality images may be used. In still other implementations, wearable electronic devices of a more elongate band shape may be worn around the wearer's bicep, waist, chest, ankle, leg, head, or other body part.

As shown in the drawings, display system 16A may include various functional electronic components: a controller 10A, display 14A, loudspeaker 20, haptic motor 22, communication facility 24, and various sensors 12. In the illustrated implementation, functional electronic components are integrated into the several rigid segments of the band-viz., display-carrier module 26A, pillow 26B, energy-storage compartments 26C and 26D, and buckle 26E. In the illustrated conformation of composite band 18, one end of the band overlaps the other end. Buckle 26E is arranged at the overlapping end of the composite band, and receiving slot 28 is arranged at the overlapped end.

The functional electronic components of wearable display system 16A draw power from one or more energy-storage components 32. A battery—e.g., a lithium ion battery—is one type of energy-storage electronic component. Alternative examples include super- and ultra-capacitors. To provide adequate storage capacity with minimal rigid bulk, a plurality of discrete, separated energy-storage components may be used. These may be arranged in energy-storage compartments 26C and 26D, or in any of the rigid segments of composite band 18. Electrical connections between the energy-storage components and the functional electronic components are routed through flexible segments 34.

In general, energy-storage components 32 may be replaceable and/or rechargeable. In some examples, recharge power may be provided through a universal serial bus (USB) port 36, which includes the plated contacts and a magnetic latch to releasably secure a complementary USB connector. In other examples, the energy-storage components may be recharged by wireless inductive or ambient-light charging.

In display system 16A, controller 10A is housed in display-carrier module 26A and situated below display 14A. The controller is operatively coupled to display 14A, loudspeaker 20, communication facility 24, and to the various sensors 12. The controller includes a computer memory machine 38 to hold data and instructions, and a logic machine 40 to execute the instructions. As described further below, the controller may use the output from sensors 12, inter alia, to determine how text is to be displayed via RSVP.

Display 14A may be any type of display, such as a thin, low-power light emitting diode (LED) array or a liquid-crystal display (LCD) array. Quantum-dot display technology may also be used. Suitable LED arrays include organic LED (OLED) or active matrix OLED arrays, among others. An LCD array may be actively backlit. However, some types of LCD arrays—e.g., a liquid crystal on silicon, LCOS array—may be front-lit via ambient light. Although the drawings show a substantially flat display surface, this aspect is by no means necessary, for curved display surfaces may also be used. In some use scenarios, display system 16A may be worn with display 14A on the front of the wearer's wrist, like a conventional wristwatch.

Communication facility 24 may include any appropriate wired or wireless communications componentry. In FIGS. 1A and 1B, the communications facility includes the USB port 36, which may be used for exchanging data between system 16A and other computer systems, as well as providing recharge power. The communication facility may further include two-way Bluetooth, Wi-Fi, cellular, near-field communication, and/or other radios. In some implementations, the communication facility may include an additional transceiver for optical, line-of-sight (e.g., infrared) communication.

In display system 16A, touch-screen sensor 12A is coupled to display 14A and configured to receive touch input from the wearer. In general, the touch sensor may be resistive, capacitive, or optically based. Push-button sensors (e.g., microswitches) may be used to detect the state of push buttons 12B and 12B′, which may include rockers. Input from the push-button sensors may be used to enact a home-key or on-off feature, control audio volume, microphone, etc.

FIGS. 1A and 1B show various other sensors 12 of display system 16A. Such sensors include microphone 12C, visible-light sensor 12D, ultraviolet sensor 12E, and ambient-temperature sensor 12F. The microphone provides input to controller 10A that may be used to measure the ambient sound level or receive voice commands from the wearer. Input from the visible-light sensor, ultraviolet sensor, and ambient-temperature sensor may be used to assess aspects of the wearer's environment.

FIGS. 1A and 1B show a pair of contact sensors—charging contact sensor 12G arranged on display-carrier module 26A, and pillow contact sensor 12H arranged on pillow 26B. The contact sensors may include independent or cooperating sensor elements, to provide a plurality of sensory functions. For example, the contact sensors may provide an electrical resistance and/or capacitance sensory function responsive to the electrical resistance and/or capacitance of the wearer's skin. To this end, the two contact sensors may be configured as a galvanic skin-response sensor, for example. In the illustrated configuration, the separation between the two contact sensors provides a relatively long electrical path length, for more accurate measurement of skin resistance. In some examples, a contact sensor may also provide measurement of the wearer's skin temperature. In the illustrated configuration, a skin temperature sensor 121 in the form a thermistor is integrated into charging contact sensor 12G, which provides direct thermal conductive path to the skin. Output from ambient-temperature sensor 12F and skin temperature sensor 121 may be applied differentially to estimate of the heat flux from the wearer's body. This metric can be used to improve the accuracy of pedometer-based calorie counting, for example. In addition to the contact-based skin sensors described above, various types of non-contact skin sensors may also be included.

Arranged inside pillow contact sensor 12H in the illustrated configuration is an optical pulse-rate sensor 12J. The optical pulse-rate sensor may include a narrow-band (e.g., green) LED emitter and matched photodiode to detect pulsating blood flow through the capillaries of the skin, and thereby provide a measurement of the wearer's pulse rate. In some implementations, the optical pulse-rate sensor may also be configured to sense the wearer's blood pressure. In the illustrated configuration, optical pulse-rate sensor 12J and display 14A are arranged on opposite sides of the device as worn. The pulse-rate sensor alternatively could be positioned directly behind the display for ease of engineering.

Display system 16A may also include inertial motion sensing componentry, such as an accelerometer 12K, gyroscope 12L, and magnetometer 12M. The accelerometer and gyroscope may furnish inertial data along three orthogonal axes as well as rotational data about the three axes, for a combined six degrees of freedom. This sensory data can be used to provide a pedometer/calorie-counting function, for example. Data from the accelerometer and gyroscope may be combined with geomagnetic data from the magnetometer to further define the inertial and rotational data in terms of geographic orientation.

Display system 16A may also include a global positioning system (GPS) receiver 12N for determining the wearer's geographic location and/or velocity. In some configurations, the antenna of the GPS receiver may be relatively flexible and extend into flexible segment 34A.

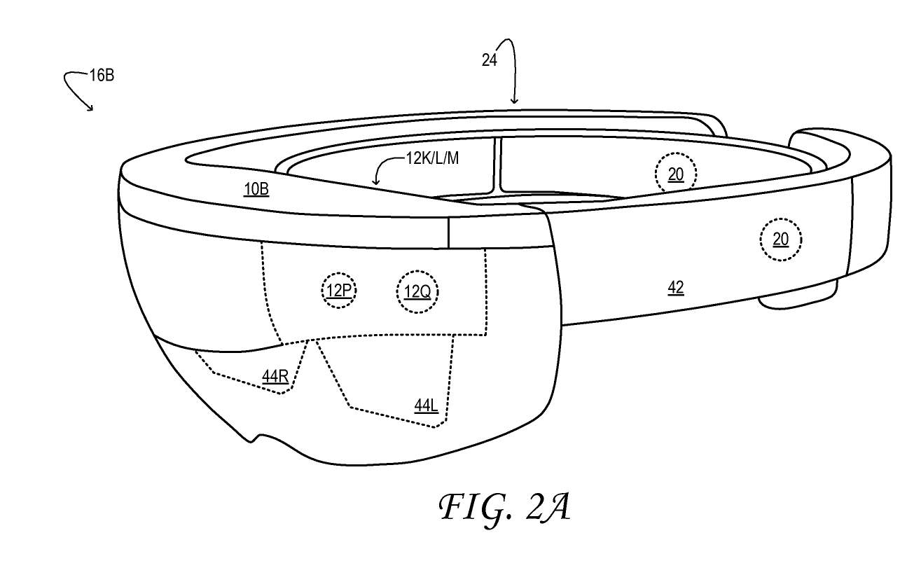

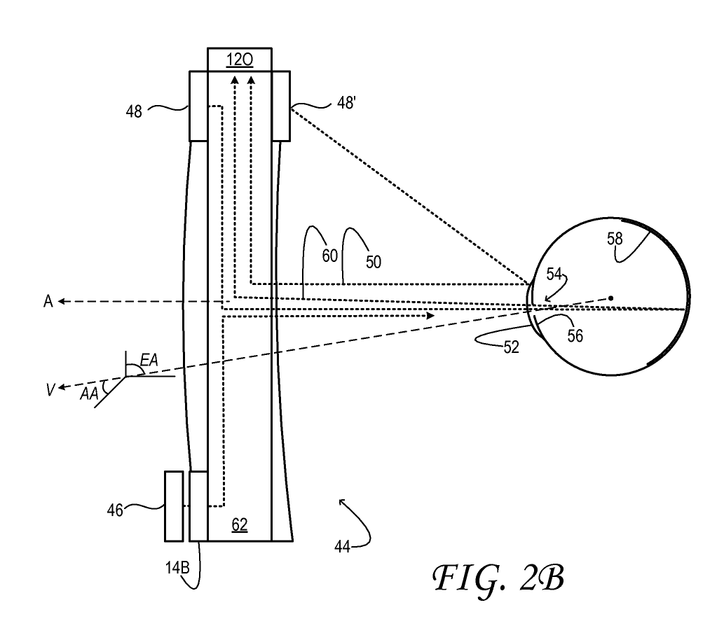

FIG. 2A shows aspects of an example head-mounted display system 16B to be worn and used by a wearer. The illustrated display system includes a frame 42. The frame supports stereoscopic, see-through display componentry, which is positioned close to the wearer's eyes. Display system 16B may be used in augmented-reality applications, where real-world imagery is admixed with virtual display imagery.

Display system 16B includes separate right and left display panels, 44R and 44L, which may be wholly or partly transparent from the perspective of the wearer, to give the wearer a clear view of his or her surroundings. Controller 10B is operatively coupled to the display panels and to other display-system componentry. The controller includes logic and associated computer memory configured to provide image signal to the display panels, to receive sensory signal, and to enact the various control processes described herein.

FIG. 2B shows selected aspects of right or left display panel 44 (44R, 44L) in one, non-limiting embodiment. The display panel includes a backlight 46 and a liquid-crystal display (LCD) type microdisplay 14B. The backlight may include an ensemble of light-emitting diodes (LEDs)—e.g., white LEDs or a distribution of red, green, and blue LEDs. The backlight may be configured to direct its emission through the LCD microdisplay, which forms a display image based on control signals from controller 10B. The LCD microdisplay may include numerous, individually addressable pixels arranged on a rectangular grid or other geometry. In some embodiments, pixels transmitting red light may be juxtaposed to pixels transmitting green and blue light, so that the LCD microdisplay forms a color image. In other embodiments, a reflective liquid-crystal-on-silicon (LCOS) microdisplay or a digital micromirror array may be used in lieu of the LCD microdisplay of FIG. 2B. Alternatively, an active LED, holographic, or scanned-beam microdisplay may be used to form right and left display images. Although the drawings show separate right and left display panels, a single display panel extending over both eyes may be used instead.

Display panel 44 of FIG. 2B includes an eye-imaging camera 120, an on-axis illumination source 48 and an off-axis illumination source 48′. Each illumination source emits infrared (IR) or near-infrared (NIR) illumination in a high-sensitivity wavelength band of the eye-imaging camera. Each illumination source may comprise a light-emitting diode (LED), diode laser, discharge illumination source, etc. Through any suitable objective-lens system, eye-imaging camera 120 detects light over a range of field angles, mapping such angles to corresponding pixels of a sensory pixel array. Controller 10B may be configured to use the output from the eye-imaging camera to track the gaze axis V of the wearer, as described in further detail below.

On- and off-axis illumination serve different purposes with respect to gaze tracking. As shown in FIG. 2B, off-axis illumination can create a specular glint 50 that reflects from the cornea 52 of the wearer's eye. Off-axis illumination may also be used to illuminate the eye for a ‘dark pupil’ effect, where pupil 54 appears darker than the surrounding iris 56. By contrast, on-axis illumination from an IR or NIR source may be used to create a ‘bright pupil’ effect, where the pupil appears brighter than the surrounding iris. More specifically, IR or NIR illumination from on-axis illumination source 48 illuminates the retroreflective tissue of the retina 58 of the eye, which reflects the light back through the pupil, forming a bright image 60 of the pupil. Beam-turning optics 62 of display panel 44 enable the eye-imaging camera and the on-axis illumination source to share a common optical axis A, despite their arrangement on the periphery of the display panel.

Digital image data from eye-imaging camera 120 may be conveyed to associated logic in controller 10B or in a remote computer system accessible to the controller via a network. There, the image data may be processed to resolve such features as the pupil center, pupil outline, and/or one or more specular glints 50 from the cornea. The locations of such features in the image data may be used as input parameters in a model—e.g., a polynomial model—that relates feature position to the gaze axis V. In embodiments where a gaze axis is determined for the right and left eyes, the controller may also be configured to compute the wearer's focal point as the intersection of the right and left gaze axes. In some embodiments, an eye-imaging camera may be used to enact an iris- or retinal-scan function to determine the identity of the wearer. In this configuration, controller 10B may be configured to analyze the gaze axis, among other output from eye-imaging camera 120 and other sensors, to determine how text is to be displayed via RSVP.

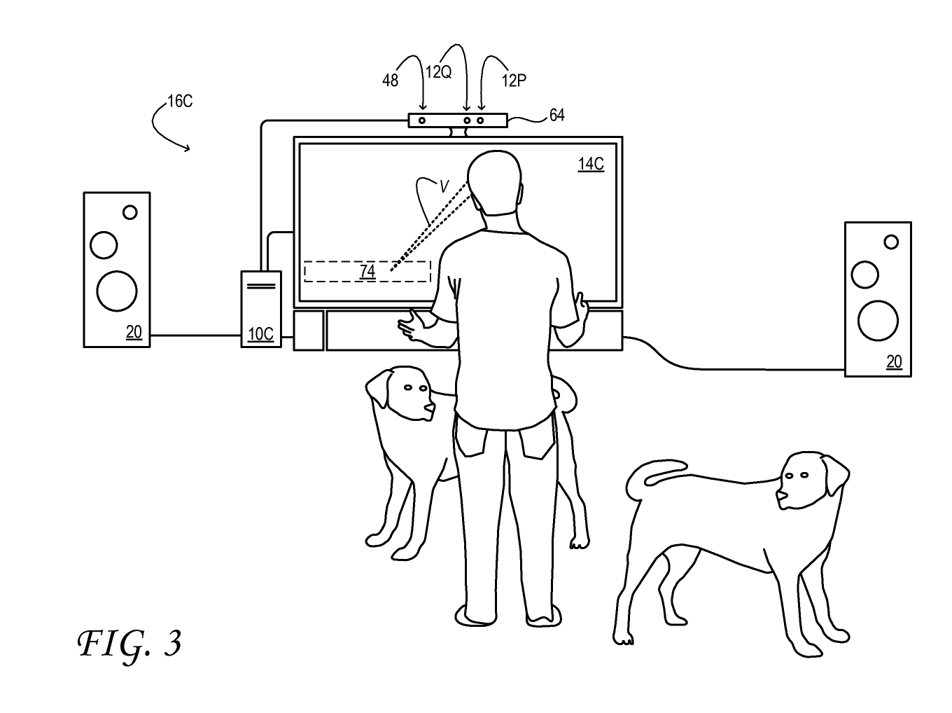

FIG. 3 shows another embodiment of a display system, in the form of home-entertainment system 16C. This display system may also function as a game system, multimedia system, or productivity system. It includes a large-format display 14C and a sensory subsystem 64 peripheral to the display. In this embodiment, controller 10C may take the form of a personal computer (PC) or game system operatively coupled to the display and to the sensory subsystem. In the embodiment of FIG. 3, the sensory subsystem includes a high-fidelity vision system with a flat-image camera 12P and depth camera 12Q for gesture detection. An IR or NIR illumination source 48 provides illumination of the viewer for eye tracking and/or depth imaging. In this configuration as well, controller 10C may use the output from the cameras and other sensors, inter alia, to determine how text is to be displayed via RSVP.

The description above should not be construed to limit the range of configurations to which this disclosure applies. Indeed, the RSVP methods described further below may be enacted on virtually any display-enabled computer system. This disclosure also embraces any suitable combination or subcombination of features from the above configurations. These include systems having both wrist-worn and head-worn portions, or a wrist-worn eye tracking facility, or a system in which remotely acquired sensory data is used to control a wearable or handheld display, for example.

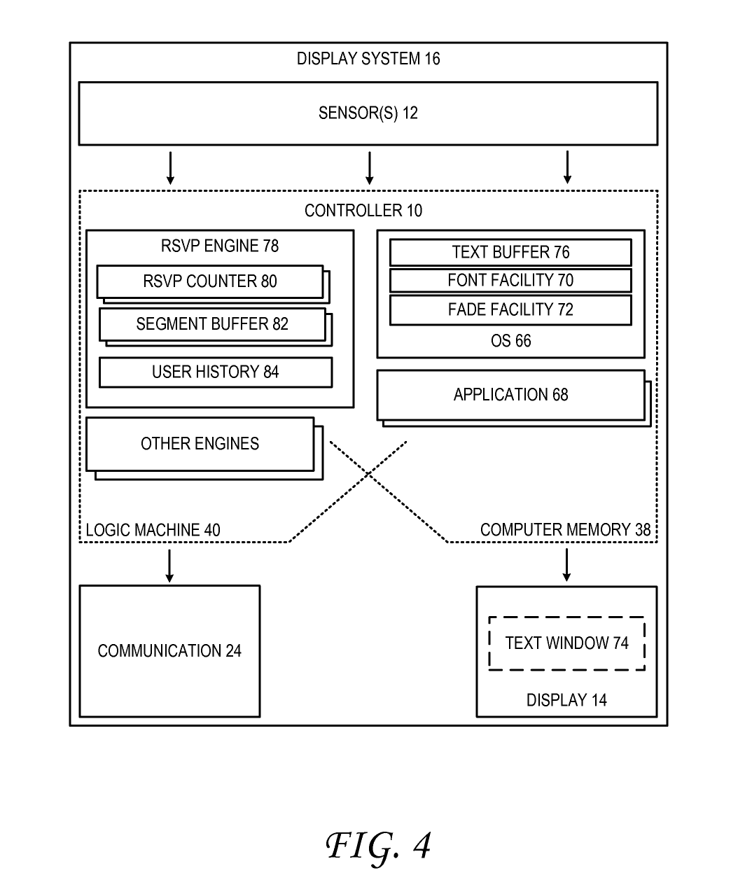

FIG. 4 schematically shows features of an example display system 16. In general, controller 10 may support an operating system (OS) 66 and one or more applications 68. The OS may include a font facility 70 for rendering text on display 14, and a fade facility 72 for controlling one or more dynamic aspects of the text—e.g., blanking, fading, a rolling-marquee effect, etc.). Text may be stored transiently in text buffer 76 of OS 66. Display 14 may include a text window 74 in which the text is displayed.

Controllers 10 may include various functional processing engines instantiated in software and/or firmware. In FIG. 4, the controller includes an RSVP engine 78. The RSVP engine includes, inter alia, at least one RSVP use counter 80, at least one segment buffer 82, and a user-history database 84. In some embodiments, the RSVP engine may include a plurality of RSVP use counters corresponding to a plurality of users of the system, and the user-history database may store data specific to each user.

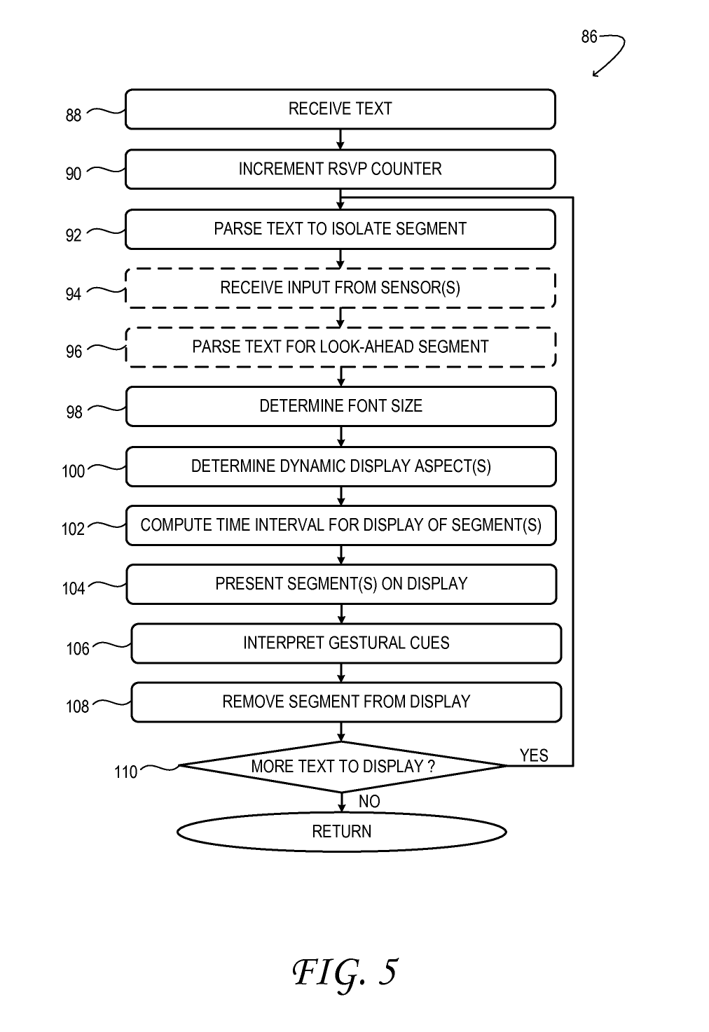

FIG. 5 illustrates an example method 86 for serial text presentation. The method may be enacted in controller 10 of display system 16, which may be operatively coupled to a display 14. Controller 10 optionally may be operatively coupled to at least one sensor 12.

At 88 of method 86, a body of text is received in controller 10 and accumulated into text buffer 76. The text may be received in any language and/or code standard supported by the controller. In some examples, the text may originate from email that a user receives on the system—a new email, for instance, or one received previously but selected currently for review by the user. In other examples the text may originate from an SMS message, a tweet, or any other form of communication containing at least some text. The text may be received through any wired or wireless communications facility 24 arranged in the system. In other examples, the text may be a notification from a program executing on the controller. In general, any form of text may be displayed according to method 86 without departing from the scope of this disclosure.

At 90, the RSVP use counter 80 for the current user of system 16 is incremented. The RSVP use counter may be incremented by one, in some examples, to indicate that the current user has received one more body of text for RSVP presentation. In other examples, the RSVP use counter may be incremented by the number of words received in the text, or by any surrogate for the length of the body of text received.

At 92 the text in text buffer 76 is parsed to isolate a first or current text segment. A ‘text segment’, as used herein, is a string of characters. The text segment isolated at 92 may typically correspond to a single word of text. In some scenarios, however, a text segment may include two or more smaller words, a word with attached punctuation, a portion of a long word, or a logical grouping of language symbols (e.g., one or more related logograms).

At 94 input from one or more sensors 12 arranged in system 16 is optionally received. Such sensors may include a touch-screen sensor 12A, push-button microswitch 12B, a microphone 12C, a visible-light sensor 12D, an ultraviolet sensor 12E, an ambient-temperature sensor 12F, a charging contact sensor 12G, a pillow contact sensor 12H, a skin-temperature sensor 121, an optical pulse-rate sensor 12J, an accelerometer 12K, a gyroscope 12L, a magnetometer 12M, a GPS receiver 12N, an eye-imaging camera 120, a flat-image camera 12P, and/or a depth camera 12Q, as examples.

Some of the example sensors 12 described above, and others within the scope of this disclosure, are posture sensors. A posture sensor is any sensor whose output is responsive to the posture of the user, or any aspect thereof. The posture may include, for instance, one or more gestures identified by the controller as user input. Inertial sensors 12K and 12L are posture sensors because they provide information on the hand or head position of the user (depending on whether the sensors are arranged in a wrist-or head-worn system). Touch-screen sensor 12A and push-button microswitches 12B are also posture sensors, as is any user-facing depth camera 12Q configured to image the user.

Some of the example sensors 12 described above, and others within the scope of this disclosure, are user-condition sensors. A user-condition sensor is any sensor whose output is responsive to a condition of the user. Pillow contact sensor 12H, skin-temperature sensor 121, and optical pulse-rate sensor 12J are user-condition sensors because they respond to physiological conditions of the user. Microphone 12C, visible-light sensor 12D, ultraviolet sensor 12, ambient-temperature sensor 12F, flat-image camera 12P, and depth-camera 12Q are user-condition sensors because they respond to environmental conditions experienced by the user. An eye-imaging camera 120 that reports on the user's gaze vector is also a user-condition sensor. Inertial sensors 12K and 12L are user-condition sensors as well as posture sensors, because they report on the state of motion of the user.

Continuing in FIG. 5, at optional step 96 the text in text buffer 76 is again parsed to isolate a ‘look-ahead text segment’. This term refers to one or more words that immediately follow the current text segment. In some embodiments, the look-ahead segment is appended to the current segment in text window 74 to give the user a preview of the subsequent text segment. This effect may be used to simulate the pre-visualization mechanism believed to increase reading comprehension. Alternative modes of presentation of the look-ahead segment are described hereinafter.

At 98, the font size desired for display of the text segment (and the look-ahead segment, if any) is determined. In some implementations, the font size will always be the same for every displayed text segment, while in some implementations the font size may be dynamically updated based on the displayed segment and/or input from one or more sensors. When the same size is always used, this determination step may be the reading of a setting and/or the acknowledgement of a programmed display instruction. In some embodiments, the determined font size may be the largest font size to allow the entire text segment to fit into text window 74. In some embodiments, the font size may be determined further based on input from one or more sensors 12. For example, the range-finding depth camera 12Q in system 16C may be used to determine the proximity of the user to display 14C. The font size may be increased, accordingly, with increasing distance between the user (e.g., the user's face) and the display, to ensure readability. In another example, eye-imaging camera 120 in system 16B may be used to determine the degree to which the user is focused on text window 74 presented on microdisplay 14B. The user's attention could be divided, for instance, between the content of the text window and some other imagery. Controller 10B may be configured to increase the font size to improve readability under such conditions. Conversely, the controller may be configured to maintain the font size when the user is maintaining a consistent focus on the text window. This action would allow longer words to fit in the text window, reducing the need to break words up and thereby increase RSVP throughput. Moreover, it may allow more consistent display of the look-ahead text segment, if desired, to improve comprehension. In system 16A, a similar approach may be taken. Here, the inertial-measurement unit comprising accelerometer 12K and gyroscope 12L may be used to determine the extent of motion of the user's hand. When the user's hand is still, the font size may be decreased, to secure the efficiency advantages noted above. When the user's hand is in motion, the font size may be increased, to improve readability.

At 100 certain dynamic aspects of the text segment presentation are determined. Dynamic aspects include whether the text segment is to be presented in a rolling-marquee fashion, or merely flashed all at once into the text window 74. A rolling marquee may be used for all words in some implementations, or only for words that are too long to fit into the text window, or when the current text segment is presented together with a look-ahead segment. In some embodiments, cross-fading may be used in the transition between current and subsequent text segments. Another variant is one in which look-ahead content is presented in the text window together with the current text segment, but the current text segment is displayed in a larger, bolder, and/or brighter font, and the look-ahead text segment is displayed in a smaller, dimmer, lighter, and/or grayed-out font. Then, at the time designated for transition to the subsequent text segment, the look-ahead text segment may gradually gain prominence (fade in) to the level of the current text segment, the current text segment may gradually lose prominence (fade out), and a new look-ahead text segment may appear.

At 102 a desired time interval for display of the text segment is computed. The object of computing the time interval at 102 is to maximize net RSVP efficiency and thereby improve the user experience. Long intervals for every segment provide good readability but poor efficiency, leading to a poor user experience. Short intervals, by contrast, increase throughput on a “per-segment” basis, but may compromise readability and comprehension. When the interval becomes too short, comprehension may suffer to the extent that the user must replay the body of text, resulting in much lower efficiency.

The following expresses, in one non-limiting implementation, a desired display time interval (TIME) as a product of factors:

TIME=BASE×USER×SEGMENT×SENSOR

In the expression above, BASE represents an unadjusted time interval for display of a non-specific word for a non-specific user, in the language of the text. BASE may be derived from a typical reading speed of an average user reader in that language. For example, if English text is read typically at a rate of 250 words per minute, then BASE may be set to 60000/250, or 240 milliseconds (ms). In some embodiments, controller 10 may select the appropriate BASE value based on the current user context—i.e., a system parameter. Wrist-worn system 16A, for example, may be operable in a plurality of different user contexts: a sleep mode, a normal mode, and a running mode. The BASE value may be 240 ms for sleep and normal modes, but somewhat longer—e.g., 400 ms in running mode. The difference is based on the fact that reading is generally more difficult for a user engaged in running than for a user engaged in ordinary activities, or lying still. It will be noted that the numerical values and ranges disclosed herein are provided only by way of example, and that other values and ranges lie within the scope of this disclosure.

Continuing, the parameters USER, SEGMENT, and SENSOR in the expression above are dimensionless factors that multiplicatively increase or decrease the BASE value to provide a TIME interval of appropriate length. Although the BASE, USER, and SENSOR parameters appear above as a product, this aspect is by no means necessary. Indeed the effect of each parameter value on the TIME interval may be registered in numerous other ways, as one skilled in the art will readily appreciate. In one alternative example, the parameters may appear as a linear combination:

TIME=BASE+A1×USER+A2×SEGMENT+A3×SENSOR+A4

where A1 through A4 are constants in units of milliseconds.

Referring to the expressions above, USER is a parameter adjustable by the system to account for natural variations in reading rate among different users irrespective of context. If a user signals to the system for faster RSVP presentation (vide infra), then the USER parameter for that user may be lowered. In contrast, if a user signals for playback of text already presented, then the USER parameter for that user may be increased. In some implementations, the USER parameter may be adjusted automatically based on changing familiarity of the current user with RSVP. To that end, USER may be set initially to a high value (e.g., USER=2), and then decreased gradually with increasing RSVP use counter value until a nominal (e.g., USER=1) value is reached.

In this manner, the TIME interval decreases automatically with repeated serial text display on the display system. Conversely, the USER parameter may be increased for a user with previous RSVP experience if significant time has passed since RSVP was last used. In other words, the TIME interval may increase automatically with increasing time since serial text display was last presented on the display system. In another embodiment, USER may be adjusted downward with increasing frequency of use of RSVP by the user, and adjusted upward with decreasing frequency of use. To provide this functionality, controller 10 may access user-history database 84. On-the-go refinement of the user parameter is also envisaged. Thus, if a user tends to play back previously read messages or portions thereof, the USER parameter may be increased automatically. Despite the benefits of automatic adjustment, the USER parameter may also be adjusted directly by the user, according to his or her preferences. Some users may want to set a more comfortable reading pace (USER=1.5), while others may want to challenge themselves to read faster (USER=0.8). Control of the USER parameter is further described below, in the context of interpreting user gestures as a form of input.

SEGMENT is a parameter adjustable by the system to account for variation in reading difficulty among different segments of text. In general, SEGMENT decreases with increasing recognizability or predictability of a word or other text segment. SEGMENT may be higher for longer words and lower for shorter words. SEGMENT may decrease with repeated presentation of a word in a given RSVP session, or across a plurality of RSVP sessions. In some implementations, SEGMENT may decrease with increasing representation of a word in a body of text with which the user is familiar (e.g., an email folder or user dictionary).

SENSOR is a parameter adjustable by the system controller to account for variation in reading difficulty as a result of the context, posture, or environment of the user during RSVP. The value assigned to the SENSOR parameter at any moment in time during an RSVP presentation may be based on the output of one or more sensors in the display system.

SENSOR may decrease with decreasing visibility of the text segment in text window 74. For example, SENSOR may increase with increasing ambient light level. In head-wearable system 16B, sensor may increase with increasing activity in the wearer's field of view, as determined via cameras 12P and 12Q of display system 16B. In these and other embodiments, SENSOR may increase or decrease based on the output of inertial sensors 12K and 12L, which report on wrist or head motion. It may be more difficult, for instance, for a user to read text when either the head or the wrist (if the display is wrist-worn) is in motion. Accordingly, SENSOR may increase with increasing motion detected by the inertial sensors. In stationary-display embodiments such as system 16C, output from a peripheral vision system 64 may be used in lieu of inertial sensor output, to determine the extent of the user's motion. In these and other embodiments, SENSOR may increase with increasing distance between the display and the user (e.g., the user's face), as determined from the time-integrated response of the inertial sensors, for example. Accordingly, the value of the SENSOR parameter may vary periodically during a user's stride, if the user is walking or running. It will be noted that this feature may be enacted independent of playback-speed reduction responsive to the motion of the user; in other examples, the two approaches may be used together.

In systems having an eye-imaging camera 120 or other gaze tracking sensor, the stability of the user's focus may be used as an indication of whether to speed up or slow down RSVP presentation. For instance, if the user's gaze remains fixed on the text window, this may be taken as an indication that the user is reading attentively. The SENSOR parameter may be maintained or further decreased, accordingly, to provide higher reading efficiency. On the other hand, if the user's gaze shifts off the displayed text segment during reading, or reveals an attempt to read in reverse, this may be taken as an indication that the presentation rate is too fast. SENSOR may therefore be increased. In the limit where the included sensory componentry reveals that the user is no longer focused on the display, RSVP presentation may be suspended. To this end, the TIME interval of the current text segment may be set to a very long value; other modes of suspending playback are envisaged as well. Also envisaged is a more general methodology in which the TIME interval is controlled based on a model of how a person's eyes move while reading.

In these and other embodiments, the SENSOR parameter may reflect the overall transient physiological stress level of the user. For example, SENSOR may increase with increasing heart rate or decreasing galvanic skin resistance of the user.

In the embodiments here contemplated, the SENSOR parameter may register the output from any combination of sensors arranged in system 16. SENSOR may be computed as a product or linear combination of such outputs, for example.

Continuing in FIG. 5, at 104 of method 86, the current text segment is presented in text window 74 of the display during the computed time interval. As noted above, a look-ahead text segment may be displayed concurrently, in some embodiments. Naturally, the various dynamic aspects determined at 100 may be applied at this stage.

At 106 the sensory architecture of the system is interrogated for any gesture from the user that could affect RSVP presentation. Some gestures maybe navigation cues. A slow, right-to-left swipe of the user's dominant hand, for example, may signal the user's intent to advance into the body of text, while a left-to-right swipe may signal the intent to play back an earlier portion of the text. In display system 16A, output from inertial sensors 12K and 12L may be used to sense the user's hand gesture; in display system 16C, skeletal tracking via depth camera 12Q may be used instead. In display system 16B, gaze-based cues may be used in lieu of hand gestures. The controller may be configured to provide user navigation within the text in response to such gestures.

In some embodiments, a user's hand gesture may be used to initiate an RSVP presentation. For example, a tap on wrist band 18 of system 16A or frame 42 of system 16B may signal the user's intent to begin an RSVP session. In some embodiments, the immediate effect of a tap gesture may vary depending on the user mode. In normal or sleep mode, for instance, a dialog may appear to query the user whether to invoke RSVP for easier reading. In running mode, RSVP may start automatically following the tap gesture.

Other gestures may relate to RSVP presentation speed. A fast right-to-left swipe of the dominant hand may signal an intent to hurry along the presentation. In that event, the USER parameter may be decreased. A hand held still, by contrast, may indicate that the presentation is advancing too quickly, so the USER parameter may be increased. The controller may be configured to modify the time interval in response to such gestures. Navigation gestures, per se, may also affect the time interval. For example, if the gestures for playback of a previously read portion of the text, the controller may interpret this as an indication that the playback speed is too high, and may increase the time interval in response to the that gesture.

In some embodiments, gestural cues may not have a persistent effect on the USER parameter, but instead may be correlated to one or more contextual aspects sensed at the time the gesture is made. Controller 10 may be configured to automatically learn such correlations and make appropriate adjustment to the SENSOR parameter when the condition occurs repeatedly. In other words, the controller may be configured to correlate the time interval to an output of the user-condition sensor based on an output of the posture sensor. One example may be that particularly low ambient light levels may make the display harder to read for a user who is especially sensitive to contrast. If that user tries to slow down the presentation under very dark conditions, the controller may learn to automatically adjust SENSOR upward under low ambient light. Hand gestures may be identified based on IMU output using display system 16A or based on skeletal tracking in display system 16C, for example.

At 108, immediately following the computed time interval (i.e., after the computed time interval has transpired), the text segment is removed from text window 74. The text segment may abruptly vanish or fade, depending on the embodiment.

At 110 it is determined whether all of the text in the body of text received at 88 has been displayed, or whether more text remains to be displayed. If more text remains, then the method returns to 92, where the body of text is parsed for the subsequent text segment. In this manner, the above acts are repeated serially for subsequent segments of the text, until all of the text has been displayed. While FIG. 5 depicts a loop in which each segment is independently parsed and each time interval is independently computed, two or more segments may be parsed in parallel and/or two or more time segments may be computed in parallel. In some implementations, for example, all text may be pre-parsed before individual segments are serially presented and removed.

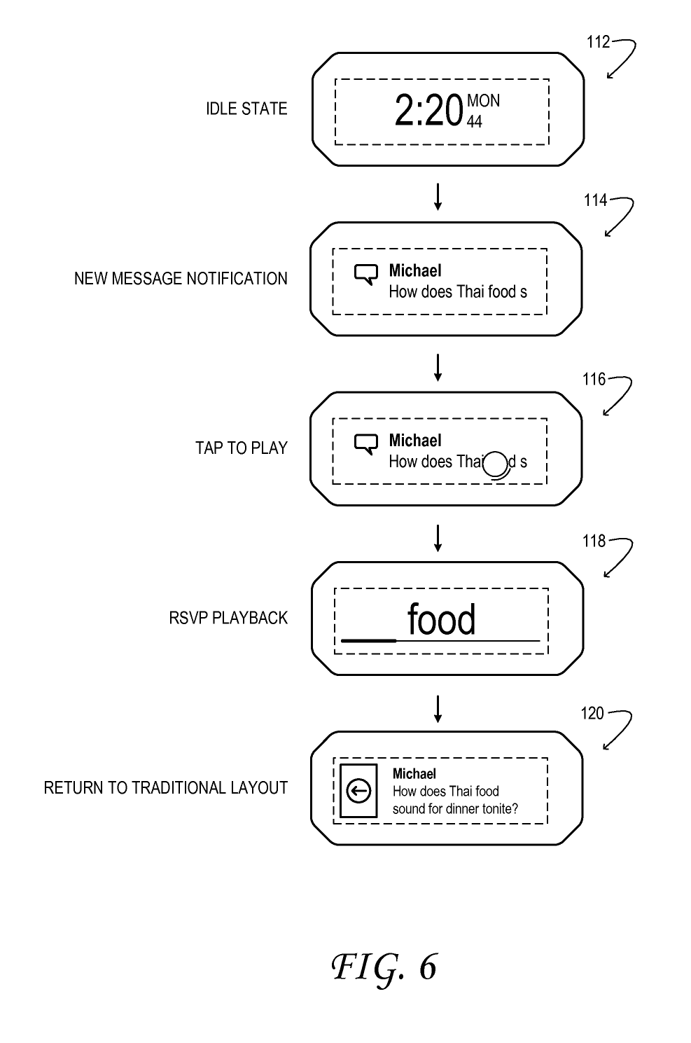

FIGS. 6 through 10 provide further illustration of aspects of the above methodology, as enacted via wrist-worn system 16A in some example scenarios. FIG. 6, in particular, illustrates receipt of a new message via RSVP. Text window 74 of system 16A is shown in an initial, idle state at 112. Then a new message arrives, bringing up a notification display at 114. The user, out for a run, sees the notification and taps the screen, at 116, causing the message to play in RSVP mode, at 118. After the message has been presented in its entirety, the system exits RSVP mode and displays the message in the default layout, at 120.

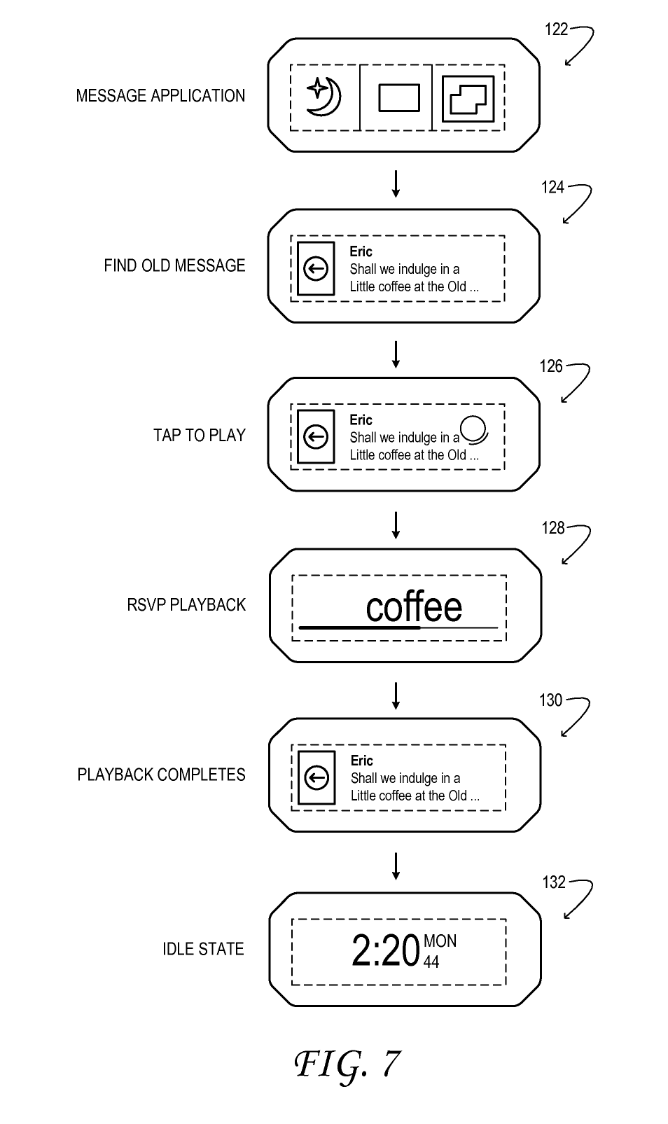

FIG. 7 illustrates viewing of an already received message via RSVP. In this scenario, the user recalls the name of the coffee shop where she planned to meet her friend. She navigates to the messaging application, at 122, and finds the message that her friend sent, at 124. The user taps the message, at 126, and reads the message in RSVP mode, at 128. The system finishes playing the message, at 130, and, in time, returns to the idle state, at 132.

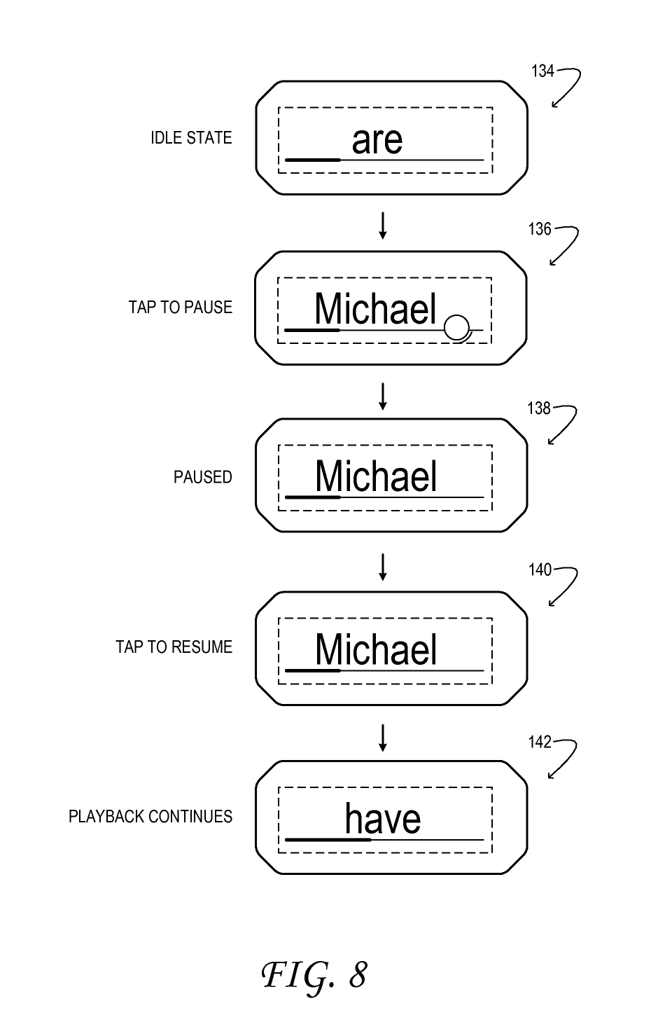

FIG. 8 illustrates the process of navigating within a message. Here the user is reading a message in RSVP mode, at 134, when a co-worker interrupts her with a question. The user taps the screen, at 136, to pause playback, at 138, and answers the question. When she is ready to continue reading, the user taps the screen again, at 140, to resume message play, at 142.

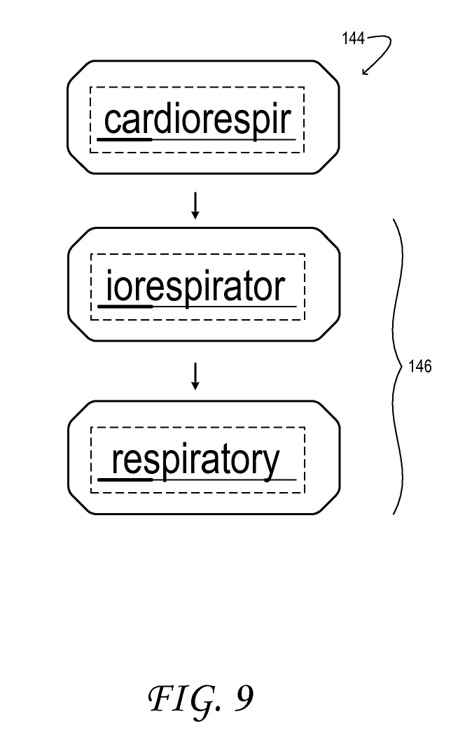

FIG. 9 illustrates a scenario in which a long word is displayed in the form of a rolling marquee. Occasionally, a body of text may contain one or more words that do not fit in text window 74 at the current font size. To display such words, the controller may briefly scroll the long word horizontally. Specifically, the text window shows the first part of the word (all that fits) at 144, and after a short delay scrolls the word horizontally to show the rest of the word, at 146. The system pauses briefly again before moving on to the next word. The total exposure time may be 1.5 times longer than normally computed, to accommodate the animation. In some implementations, the text window may accommodate words up to eleven or twelve characters in length. Accordingly, the rolling marquee need only be used for words that are twelve to thirteen characters or longer. An alternative to the rolling marquee is to hyphenate words, but that requires additional resources (e.g., a hyphenation dictionary). The TIME interval optionally may be adjusted to give readers extra time to re-integrate all the parts of the hyphenated word in their minds.

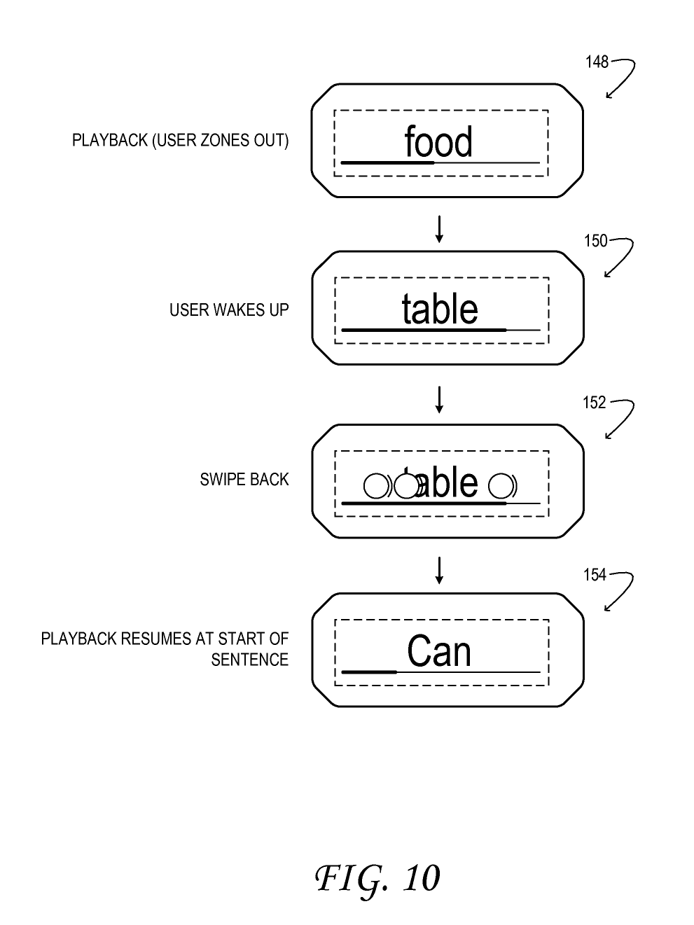

FIG. 10 illustrates the act of navigating within an RSVP-presented message. In this scenario, the user is reading a message, at 148, when her mind drifts away. Regaining her focus, the user looks back at the text window, at 150, to notice she has missed something. The user swipes backwards, at 152, to jump back one sentence. Recognizing the beginning of a sentence she already read, then resumes reading, at 154. In an alternative implementation, the system could interpret input from a gaze-tracking sensor (if available in the system), which indicates that the user was looking away in reverie. In that event, RSVP playback may pause automatically, so that the user misses almost nothing.

As evident from the foregoing description, the methods and processes described herein may be tied to a computer system of one or more computing machines. Such methods and processes may be implemented as a computer-application program or service, an application-programming interface (API), a library, and/or other computer-program product. FIG. 4 shows a non-limiting example of a computer system in the form of controller 10, which supports the methods and processes described herein. The computer system includes a logic machine 40 and associated computer memory machine 38.

Logic machine 40 includes one or more physical logic devices configured to execute instructions. A logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Logic machine 40 may include one or more processors configured to execute software instructions. Additionally or alternatively, a logic machine may include one or more hardware or firmware logic machines configured to execute hardware or firmware instructions. Processors of a logic machine may be single-core or multi-core, and the instructions executed thereon may be configured for sequential, parallel, and/or distributed processing. Individual components of a logic machine optionally may be distributed among two or more separate devices, which may be remotely located and/or configured for coordinated processing. Aspects of a logic machine may be virtualized and executed by remotely accessible, networked computing devices configured in a cloud-computing configuration.

Computer memory machine 38 includes one or more physical, computer-memory devices configured to hold instructions executable by the associated logic machine 40 to implement the methods and processes described herein. When such methods and processes are implemented, the state of the computer memory may be transformed—e.g., to hold different data. Computer memory may include removable and/or built-in devices; it may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Computer memory may include volatile, nonvolatile, dynamic, static, read/write, read-only, random-access, sequential-access, location-addressable, file-addressable, and/or content-addressable devices.

It will be appreciated that computer memory machine 38 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 40 and computer memory machine 38 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term ‘engine’ may be used to describe an aspect of a computer system implemented to perform a particular function. In some cases, an engine may be instantiated via a logic machine executing instructions held in computer memory. It will be understood that different engines may be instantiated from the same application, service, code block, object, library, routine, API, function, etc. Likewise, the same engine may be instantiated by different applications, services, code blocks, objects, routines, APIs, functions, etc. The term ‘engine’ may encompass individual or groups of executable files, data files, libraries, drivers, scripts, database records, etc.

Communication facility 24 may be configured to communicatively couple the computer system to one or more other machines. The communication system may include wired and/or wireless communication devices compatible with one or more different communication protocols. As non-limiting examples, a communication system may be configured for communication via a wireless telephone network, or a wired or wireless local- or wide-area network. In some embodiments, a communication system may allow a computing machine to send and/or receive messages to and/or from other devices via a network such as the Internet.

The configurations and approaches described herein are exemplary in nature, and that these specific implementations or examples are not to be taken in a limiting sense, because numerous variations are feasible. The specific routines or methods described herein may represent one or more processing strategies. As such, various acts shown or described may be performed in the sequence shown or described, in other sequences, in parallel, or omitted.

As described above, one aspect of this disclosure is directed to a display system configured for serial text presentation. The display system comprises a display and a controller. The controller is operatively coupled to the display and configured to: parse text to isolate a sequence of consecutive segments of the text, serially present each segment on the display and remove each segment from the display at a rate set to an initial value, monitor user response to the rate of presentation, and dynamically adjust the rate of presentation based on the user response.

In some implementations, dynamically adjusting the rate includes increasing the rate with repeated presentation of text on the display system. In some implementations, dynamically adjusting the rate includes automatically decreasing the rate with increasing time since serial text presentation was last presented on the display system.

Another aspect of this disclosure is directed to a display system configured for serial text presentation. The display system comprises a display, a posture sensor responsive to a posture aspect of a user, and a controller operatively coupled to the display and to the posture sensor. The controller is configured to: parse text to isolate a sequence of consecutive words of the text, compute, for each of the consecutive words, a time interval for display of that word based on input from the posture sensor, serially present each word on the display during the computed time interval for that word, and remove each word from the display following its computed time interval.

In some implementations, computing the time interval includes increasing the time interval with increasing distance between the user and the display. In some implementations, computing the time interval includes increasing the time interval with increasing motion of the user. In some implementations, the posture aspect includes one or more gestures identified by the controller as user input. For instance, the posture aspect may include a first gesture, and the controller may be further configured to provide user navigation within the text in response to the first gesture. In these and other implementations, the posture aspect may include a second gesture, and the controller may be further configured to modify the time interval in response to the second gesture. In some implementations, the second gesture may signal playback of a previously read portion of the text, and the controller may be further configured to increase the time interval in response to the second gesture. In some implementations, the display system may further comprise a user-condition sensor responsive to a condition of the user; here, the controller may be further configured to correlate the time interval to an output of the user-condition sensor based on an output of the posture sensor. In some implementations, the posture sensor may include an inertial sensor responsive to hand or head motion of the user.

Another aspect of this disclosure is directed to a display system configured for serial text presentation. The display system comprises a display, a user-condition sensor responsive to a condition of the user, and a controller operatively coupled to the display and to the user-condition sensor. The controller is configured to: parse text to isolate a segment of the text, compute a time interval for display of the segment based on input from the user-condition sensor, present the segment on the display during the computed time interval, remove the segment from the display following the computed time interval, and repeat the parsing computing, presenting, and removing, for every subsequent segment of the text.

In some implementations, the user-condition sensor may be responsive to physiological stress of the user, and computing the time interval may include increasing the time interval with increasing physiological stress. In some implementations, the user-condition sensor may be responsive to user focus on the display, and computing the time interval may include increasing the time interval with decreasing user focus on the display. In some implementations, the user-condition sensor may be responsive to visibility of the display to the user, and computing the time interval may include increasing the time interval with decreasing visibility. In some implementations, the user-condition sensor may be responsive to activity in a field of view of the user, and computing the time interval may include increasing the time interval with increasing activity in the field of view. In some implementations, the user-condition sensor includes a gaze-estimation sensor configured to estimate a gaze axis of the user. In some implementations, the segment is a current segment, and the controller is further configured to parse the text to isolate a look-ahead segment, which immediately follows the current segment in the text, and to display the current and look-ahead segments concurrently. In some implementations, the display includes a text window, and presenting the segment includes presenting as a rolling marquee if the segment would otherwise overfill the text window.

The subject matter of this disclosure includes all novel and non-obvious combinations and sub-combinations of the various processes, systems and configurations, and other features, functions, acts, and/or properties disclosed herein, as well as any and all equivalents thereof.

1. A display system configured for serial text presentation, comprising:
a display; and
a controller operatively coupled to the display and configured to:
parse text to isolate a sequence of consecutive segments of the text,
serially present each segment on the display and remove each segment from the display at a rate set to an initial value,
monitor user response to the rate of presentation, and
dynamically adjust the rate of presentation based on the user response.

2. The display system of claim 1, wherein dynamically adjusting the rate includes increasing the rate with repeated presentation of text on the display system.

3. The display system of claim 1, wherein dynamically adjusting the rate includes automatically decreasing the rate with increasing time since serial text presentation was last presented on the display system.

4. A display system configured for serial text presentation, comprising:
a display;
a posture sensor responsive to a posture aspect of a user; and
a controller operatively coupled to the display and to the posture sensor, the controller configured to:
parse text to isolate a sequence of consecutive words of the text,
compute, for each of the consecutive words, a time interval for display of that word based on input from the posture sensor,
serially present each word on the display during the computed time interval for that word, and
remove each word from the display following its computed time interval.

5. The display system of claim 4, wherein computing the time interval includes increasing the time interval with increasing distance between the user and the display.

6. The display system of claim 4, wherein computing the time interval includes increasing the time interval with increasing motion of the user.

7. The display system of claim 4, wherein the posture aspect includes one or more gestures identified by the controller as user input.

8. The display system of claim 7, wherein the posture aspect includes a first gesture, and wherein the controller is further configured to provide user navigation within the text in response to the first gesture.

9. The display system of claim 7, wherein the posture aspect includes a second gesture, and wherein the controller is further configured to modify the time interval in response to the second gesture.

10. The display system of claim 9, wherein the second gesture signals playback of a previously read portion of the text, and wherein the controller is further configured to increase the time interval in response to the second gesture.

11. The display system of claim 7, further comprising a user-condition sensor responsive to a condition of the user, and wherein the controller is further configured to correlate the time interval to an output of the user-condition sensor based on an output of the posture sensor.

12. The display system of claim 4, wherein the posture sensor includes an inertial sensor responsive to hand or head motion of the user.

13. A display system configured for serial text presentation, comprising:
a display;
a user-condition sensor responsive to a condition of a user; and
a controller operatively coupled to the display and to the user-condition sensor, the controller configured to:
parse text to isolate a segment of the text,
compute a time interval for display of the segment based on input from the user-condition sensor,
present the segment on the display during the computed time interval,
remove the segment from the display following the computed time interval, and
repeat the parsing computing, presenting, and removing, for every subsequent segment of the text.

14. The display system of claim 13, wherein the user-condition sensor is responsive to physiological stress of the user, and wherein computing the time interval includes increasing the time interval with increasing physiological stress.

15. The display system of claim 13, wherein the user-condition sensor is responsive to user focus on the display, and wherein computing the time interval includes increasing the time interval with decreasing user focus on the display.

16. The display system of claim 13, wherein the user-condition sensor is responsive to visibility of the display to the user, and wherein computing the time interval includes increasing the time interval with decreasing visibility.

17. The display system of claim 13, wherein the user-condition sensor is responsive to activity in a field of view of the user, and wherein computing the time interval includes increasing the time interval with increasing activity in the field of view.

18. The display system of claim 13, wherein the user-condition sensor includes a gaze-estimation sensor configured to estimate a gaze axis of the user.

19. The display system of claim 13, wherein the segment is a current segment, wherein the controller is further configured to parse the text to isolate a look-ahead segment, which immediately follows the current segment in the text, and to display the current and look-ahead segments concurrently.

20. The display system of claim 13, wherein the display includes a text window, and wherein presenting the segment includes presenting as a rolling marquee if the segment would otherwise overfill the text window.
